(19) United States
(12) Patent Application Publication
(10) Pub. No.: US 2026/0024116 A1
(43) Pub. Date: Jan. 22, 2026

(54) ARTIFICIAL INTELLIGENCE ENHANCED INTERFACE FOR OUT-OF-HOME MEDIA CONTENT GENERATION AND MEDIUM SELECTION

(71) Applicant: Adomni Inc., Las Vegas, NV (US)

(72) Inventors: Jonathan Gudai, Las Vegas, NV (US); Nicholas Babb, Faifax, VA (US)

(21) Appl. No.: 19/270,876

(22) Filed: Jul. 16, 2025

Related U.S. Application Data
(60) Provisional application No. 63/672,615, filed on Jul. 17, 2024.

(51) Int. Cl. G06Q 30/0241; G06Q 30/0251

(52) U.S. Cl. CPC G06Q 30/0276; G06Q 30/0265

(57) ABSTRACT

The present disclosure provides a system for building an out of home (OOH) media content campaign to address inefficiencies in manually selecting OOH advertising mediums. The system includes a platform for identifying OOH media content mediums, a datastore with data associated with the OOH media content mediums, and a virtual assistant. The virtual assistant receives user input, modifies a query using prompt engineering based on the input and the data, transmits the query to an AI trained to identify parameters associated with the OOH media content mediums, and receives an AI response indicating parameters. The technology selects the parameters identified by the AI response and, based on the selected parameters, causes the platform to identify particular OOH media content mediums relevant to the OOH media content campaign.

### CROSS-REFERENCE TO RELATED APPLICATION(S)

This application claims priority to U.S. Provisional Patent Application No. 63/672,615, filed Jul. 17, 2024, the disclosure of which is incorporated herein by reference in its entirety.

### TECHNICAL FIELD

This disclosure generally relates to artificial intelligence (“AI”), in particular to an AI interface for building advertising campaigns.

### BACKGROUND

Marketing materials are displayed to the public in various forms of advertising. One such type of advertising can include out of home (OOH) advertising, which refers to advertising that occurs outside of the home of a consumer. An example of an OOH advertising medium includes a billboard displayed to consumers in an environment. Examples of suitable environments for OOH advertising include restaurants, convenience stores, medical facilities, highways, etc. Further information regarding OOH advertising may be found in U.S. Pat. Nos. 11,514,474 and 11,954,706, which are herein incorporated by reference in their entireties.

Artificial intelligence (“AI”) models often operate based on extensive and enormous training models. The models include a multiplicity of inputs and how each should be handled. Then, when the model receives a new input, the model produces an output based on patterns determined from the data the model was trained on.

Large language models (“LLMs”) are trained using large datasets to enable them to perform natural language processing (“NLP”) tasks such as recognizing, translating, predicting, or generating text or other content. One example of an existing LLM is ChatGPT. A recent trend in AI is to make use of general-purpose generative AI applications built on LLMs. An example of such an application is the ChatGPT family of OpenAI models. These sorts of models make use of a natural language chat interface for humans to make requests to the AI. At the time of filing, general-purpose generative AI's first attempt at responding to a user's queries is middling and requires query refinement from the user. Over the course of a given chat session, the user refines their queries, and the general-purpose model provides a better response.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 is a block diagram of an environment for implementing an online platform, in accordance with various embodiments.

FIG. 2 is a flow diagram illustrating a process to display marketing materials on a selected OOH advertising medium, in accordance with various embodiments.

FIG. 3 is a block diagram of a process for showing a series of advertisements on an OOH advertisement medium, in accordance with various embodiments.

FIG. 4 is a flow diagram illustrating a process for building an advertising campaign using an AI assistant, in accordance with various embodiments.

FIGS. 5A-5H are example GUIs for searching for advertising panels and submitting ad content for displaying in an advertising panel, in accordance with various embodiments.

FIG. 6 is a block diagram illustrating an example computer system 600, in accordance with various embodiments.

FIG. 7 is a high-level block diagram illustrating an example AI system, in accordance with various embodiments.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. These concepts and applications fall within the scope of the disclosure and the accompanying claims.

Embodiments may be described with reference to particular computer programs, system configurations, networks, etc. However, those skilled in the art will recognize that these features are equally applicable to other computer program types, system configurations, network types, etc. For example, although the term “Wi-Fi network” may be used to describe a network, the relevant embodiment could be deployed in another type of network.

Moreover, the disclosed technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device (e.g., a base station or a network-connected computer server) to implement an online platform configured display selected advertiser content on out of home (OOH) advertising mediums.

### Terminology

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, may refer to any connection or coupling, either direct or indirect, between two or more elements. The coupling or connection between the elements can be physical, logical, or a combination thereof.

References to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”).

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing multiple tasks.

When used in reference to a list of multiple items, the word “or” is intended to cover all of the following interpretations: any of the items in the list, all of the items in the list, and any combination of items in the list.

The sequences of steps performed in any of the processes described herein are exemplary. However, unless contrary to physical possibility, the steps may be performed in various sequences and combinations. For example, steps could be added to, or removed from, the processes described herein. Similarly, steps could be replaced or reordered. Thus, descriptions of any processes are intended to be open-ended.

### Overview

Advertisements are displayed to consumers using various mediums. One subset of mediums includes out of home (OOH) advertising mediums. Example OOH advertising mediums include electronic panels, billboards, etc., displayed in a publicly accessible environment. Examples of suitable environments for OOH advertising include restaurant, convenience stores, medical facility, highways, etc.

In many cases, an advertiser manually performs multiple steps to display specific marketing materials in an OOH advertising environment. However, performing these steps for OOH advertising can be time consuming and inefficient for both the advertiser and the owner of the OOH advertising medium (e.g., the billboard owner).

Further, the likelihood of the advertiser not finding a suitable OOH advertising medium may be great, as the advertiser may be unaware of potentially suitable OOH advertising mediums, particularly if the advertiser is located far from the OOH advertising medium. Additionally, owners of the OOH advertising medium are often unable to identify and attract advertisers to display their marketing materials on OOH advertising medium of the owner. Consequently, time slots available for the OOH advertising medium go unsold.

In many cases, advertisers search a computer network (e.g., the internet) for websites containing information relating to various OOH advertising mediums. However, the advertiser may be unable to find such information without multiple search queries. This leads to inefficient use of computational and network resources. In addition, even if advertisers are able to identify potential OOH advertising media, advertisers still often need to perform extensive research or work closely with a human account manager over many iterations to determine the optimal timing, format, location, pricing, and other parameters, as suited to their needs.

To address these issues, the present embodiments relate to an interface including a virtual assistant (also referred to as a “chatbot”) that assists users in planning or building an advertising campaign. A “campaign” in this document refers to one or more advertisements for display on at least one advertising medium. The virtual assistant generates an advertising plan based on the user's advertising goals, locates a suitable inventory of OOH advertising media, and launches the advertising plan, through an automated chat session with the user. Throughout the automated chat session, the chatbot replies to messages from the user, answers questions from the user, and asks questions, presents options, or solicits inputs from the user.

In some embodiments, the virtual assistant generates mockups to simulate how an advertisement would appear on an OOH advertising medium. For example, the virtual assistant receives an upload of an image, video, or attachment, which is then displayed on a digital billboard in a realistic manner in an image of the environment in which the billboard physically resides. In some cases, the image, video, or attachment is manually uploaded or referenced in a link provided by the user, while in other cases, the virtual assistant automatically accesses third-party websites for content, such as licensed or open-source content.

In some embodiments, the virtual assistant generates or refines images or videos for advertisements though the automated chat session. For example, the virtual assistant implements AI tools such as Midjourney, OpenAI Sora, etc., to generate images, music, and/or video for an advertisement, and then the AI-generated advertisement is used in a mockup, rather than using an uploaded or linked image or video.

In some embodiments, the virtual assistant is integrated with an online platform that facilitates the selection of OOH advertising mediums. The online platform allows advertisers to search for OOH advertising mediums, reserve an advertising panel, upload an advertisement (or “ad”), and have the ad displayed on the advertising panel. An advertising panel includes a digital screen-based panel or a non-digital screen-based panel. Using the platform, an advertiser searches for advertising panels using one or more search parameters. Example parameters used in building a campaign are described throughout this document and include location (e.g., state, zip, DMA, custom geofence), selected audience (e.g., demographics, behaviors, interests, brand shoppers), ad play price, budget, frequency of ad play, impressions, CPM (cost per mille, e.g., using ad play price+impressions), ad duration, or visit frequency (e.g. average number of times a visitor had Opportunity To See (OTS) per week).

By integrating the virtual assistant, the outputs of the AI model are used to perform actions that the advertiser would otherwise perform manually. For example, the virtual assistant determines the most relevant parameters based on a specialized model and the user conversation with the chatbot, and the outputs are used to inform which OOH advertising media to build an advertising campaign with.

The online platform allows advertising panel owners to publish their advertising panels to advertisers, manage availability of time slots, set a price for displaying an ad, approve or reject the ad for display on their advertising panel, and receive payment for displaying the ad. The online platform may generate report(s) for advertisers and/or advertising panel owners providing various information, such as a proof of play, a number of times an ad was displayed, a number of audience expected to have viewed the ad, demographics of the audience, an occupancy of the advertising panel, and financial information.

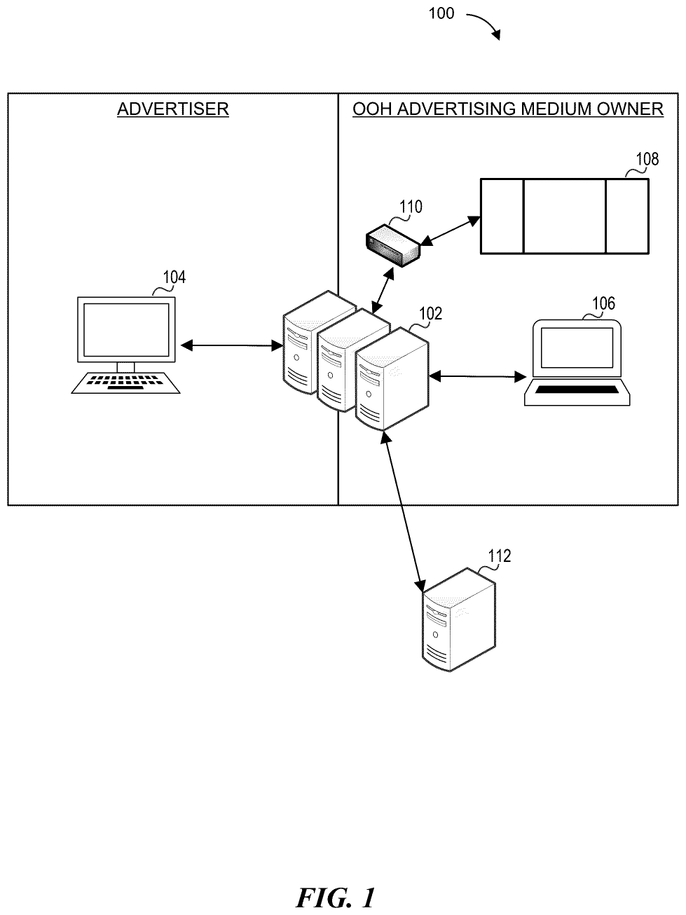

FIG. 1 is a block diagram of an environment 100 for implementing an online platform, in accordance with various embodiments. As shown in FIG. 1, a server 102 implements an online platform. In some embodiments, the server 102 includes a network-accessible server system representing one or more interconnected computing devices configured to process information and transmit information between the interconnected servers.

An advertiser interacts with the online platform via a network-accessible device (e.g., computer 104). For example, an advertiser on the advertiser device (e.g., computer 104) access the online platform and virtual assistant by connecting to the server 102 via a network (e.g., the internet). The virtual assistant is implemented using an AI system running on a server (e.g., server 102), further described in detail below.

An advertiser accesses the online platform to select one or more OOH advertising mediums to display ads associated with the advertiser. Particularly, the advertiser views a plurality of potential OOH advertising mediums (e.g., advertising panels, electronic billboards) and information relating to each potential OOH advertising medium. The advertiser selects one or more OOH advertising mediums to have an advertisement displayed on the selected OOH advertising mediums.

In addition, OOH advertising medium owners (or “panel owners”) access the online platform via a device (e.g., laptop 106). The OOH advertising medium owner is an authorized entity that owns/controls the advertisements on a OOH advertising medium. For example, the OOH advertising medium owner owns an electronic panel (e.g., panel 108), and the OOH advertising medium owner offers available time slots to have advertisements display on the panel 108 at the time slots. The panel 108 is controlled by a panel control module 110.

A panel control module 110 obtains one or more ads from server 102 and renders the ads on the panel 108. The panel control module 110 supports rendering of multiple types of media on the panel 108, such as images, video, audio, animations, etc. As discussed below, the panel control module 110 displays ads on the panel 108 at specified time periods.

The server 102 stores various data associated with the online platform, such as data associated with screen owners, advertising panels, advertisers, and ads. The various entities in the environment 100 communicate with one another over a communication network, such as the Internet, a local area network (LAN), a wide area network (WAN), etc.

The online platform can be implemented in various configurations. For example, in a first configuration, the online platform is implemented as a website hosted by the server 102. The website is used by the advertisers (e.g., using their client devices 104, for searching for the advertising panels 108 and submitting their ads for display on the advertising panels. The website is used by the screen owners (e.g., using owner device 106) to manage advertising panels. Managing advertising panels on the online platform can include any of registering an advertising panel with the online platform for making it available for advertisers, providing various details of the advertising panel, setting the price for displaying an ad, setting the availability schedule, etc.

In another configuration, at least a portion of the online platform is implemented as an application executing on a client device (e.g., client device 104 and/or client device 106). The application communicates with the server 102 to perform various functionalities of the online platform. Client devices 104, 106 are any network-enabled computing device, such as a desktop, a laptop, a smartphone, a tablet, a wearable device, etc.

In some embodiments, the server 102 communicates with a third-party server 112. Third party server(s) 112 provide various information to be used with the online platform, as discussed in greater detail below. For example, the AI system facilitating the virtual assistant can be implemented at least partially using the third-party server 112.

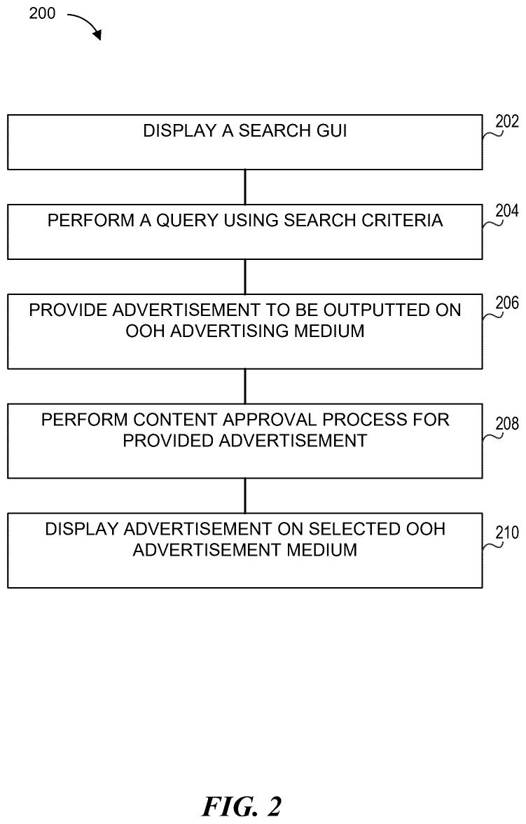

FIG. 2 is a flow diagram illustrating a process 200 to display marketing materials on a selected OOH advertising medium, in accordance with various embodiments. As noted above, an online platform facilitates the selection of an OOH advertising medium (e.g., panel) and display of marketing materials (e.g., an advertisement). The online platform generates a display (or graphical user interface (GUI)) providing a plurality of potential OOH advertising mediums (block 202). An advertiser searches for potential OOH advertising mediums on the search GUI.

In some embodiments, a listing of potential OOH advertising mediums is accompanied by information relating to each potential OOH advertising medium. Example information relating to each potential OOH advertising medium includes geographic information, panel ownership information, panel time slot availability information, price information, etc.

The advertiser uses various parameters to narrow the group of advertising panels the advertiser is interested in. For example, a geographical location parameter allows the advertiser to search for an advertising panel by a geographical location (e.g., street name, city, state, zip code). In another example, an advertising panel type parameter allows the advertiser to search for an advertising panel by type (e.g., a digital billboard, an indoor advertising panel, a shopping mall advertising panel, a mobile display, a taxicab advertising panel, a bus stop advertising panel, a coffee shop advertising panel). In another example, a target audience parameter allows the advertiser to search for an advertising panel by target audience (e.g., minimum number of target audience, income of target audience, ethnicity, gender, age group, or other such categories.)

The advertiser inputs a search criterion for finding the preferred advertising panels in a search GUI. The online platform performs a query with the search criteria on the server and generates a list of advertising panels that satisfies the search criteria (block 204). The advertiser selects an advertising panel from the list and views additional information associated with the selected digital billboard. The online platform provides a variety of advertising panel information, such as a location of the digital billboard, owner of the digital billboard, available time slots on the digital billboard, a price of an ad play on the digital billboard, an image of the digital billboard, a live video feed showing the digital billboard, a content type supported by the digital billboard, and a screen size of the digital billboard.

Responsive to the advertiser selecting a selected advertising panel, the advertiser provides or identifies the advertisement that is to be displayed on the selected advertising panel (block 206). After identifying a satisfactory advertising panel based on the advertiser search, the advertiser inputs the ad that is to be displayed. The advertiser can upload the ad, which can be an existing ad of the advertiser or generated using a third-party server, chosen an ad from a content library in the online platform that may include ads associated with the advertiser. In some embodiments, the advertiser designs an ad using an online content creation tool of the server that may provide the necessary tools for designing the ad (e.g., an AI ad generation tool). The advertiser may also input scheduling information for displaying the ad in the digital billboard, such as a period (e.g., start date and end date, for which the ad should be displayed, any specific time of the day the ad should be displayed, and an ad delivery method.)

In some embodiments, after selecting the digital billboard, uploading/designing the ad and inputting the ad details in the GUI, the advertiser adds the selected digital billboard to a shopping cart and completes a checkout process (e.g., the advertiser making the necessary payments for the advertisement). After the checkout process is successful, the server may send a notification (e.g., via email, to the screen owner associated with the digital billboard to review the ad).

The content included in the advertisement to be displayed on the selected OOH advertisement medium may be approved in a content review process (block 208). The screen owner reviews the ad and approves or rejects the ad for display on the digital billboard. The content approval process includes various criteria and can be automated and/or manual. For example, the server can automatically check whether the ad content type (e.g., image, video, or animated image), is compatible with the digital billboard and whether the content matches the display's settings for allowed content (e.g., video length in seconds to match the display's ad duration, height and width of the content for exact match or aspect ratio match). If one or more of the checks fail, the server notifies the advertiser accordingly. The notification to the advertiser also includes a reason for rejection and/or a solution to overcome the rejection. In some embodiments, the automated check is performed using the virtual assistant, which is trained to inspect and approve ad content.

In some embodiments, content review process includes detecting various objects/characteristics included in the advertisement and comparing the detected objects/characteristics against a set of rules associated with the panel owner. For example, a rule indicates that no more than 7 words are to be included in an advertisement. In this example, the content review process includes identifying a number of words in an advertisement and determining whether the advertisement includes more than 7 words. The advertisement is approved by the system when the advertisement satisfies all rules associated with the panel owner.

In some embodiments, a notification is also sent to an admin user associated with the online platform, and the admin user may also approve or reject the ad content for reasons that are the same or different as the screen owner. For example, the admin user checks the content against a set of content guidelines such as no alcohol, no competitive businesses, etc. The virtual assistant can similarly be trained to perform these functions.

In some embodiments, the server sends the awaiting approval notification to the admin user prior to the screen owner. Further, the screen owner is notified only if the ad is approved by the admin user. The screen owner performs the same check as the admin user and/or any other checks they want to do and either approves or rejects the content.

The panel control modules perform various content processing (e.g., image processing, video processing and/or audio processing, in order to make the content suitable for being displayed on their corresponding advertising panels. For example, the panel control module includes a content stitching component that stitches different portions of the content uploaded by the advertiser into one content and display the content across multiple screens such that each screen displays a portion of the content.

In some embodiments, multiple advertising panels are arranged such that each plays one piece of content (e.g., taxi top screens). These screens are sold as one unit, but on a vehicle, they may be 3 screens arranged in a triangle pattern. The two sides may be the same size and aspect ratio and the rear screen being a different size and aspect ratio. The panel control module that is configured to render the content on the screen needs one piece of content where the left side of the content gets played on the side screens and the right side of the content gets played on the rear screen. The left side of the content may need to have the aspect ratio changed, and the end result of what the panel control module needs can be complicated. So, the online platform requests the advertiser to upload two pieces of content—one for the sides with the correct dimensions (e.g., height and width and type—image, video or animated image, and another piece of content for the rear. The panel control module formats (e.g., stitch, the two different pieces of content into one piece of content formatted the correct way) the content to fit correctly on the screens.

Another example of content processing includes breaking the content into multiple pieces so that each piece is formatted accordingly to be displayed on one screen from a combination of screens. The panel control module includes a content scalpel component that performs the above processing. A content scalpel component, like a content stitch component, makes it easier for advertisers to submit content. Some advertising panels may need a piece of content to be broken up into different segments and placed in different coordinates (x, y) of the piece of content that gets played by the panel control module. For example, an advertising panel is significantly wider compared to its height. It may be that the screen is actually 4 screens next to each other that looks like one screen and is just showing a piece of the content. The advertiser provides one piece of content that is very wide but not very tall. The content scalpel component in the panel control module splits the content of a piece of content that is actually a square into 4 pieces and stacks them on top of each other to accommodate all of the screens.

Responsive to the selected advertisement being approved, the advertisement is displayed on the selected OOH advertisement medium at the predetermined time slot(s) (block 210). As an example, an image of the advertisement is displayed on an electronic billboard periodically (e.g., for ten seconds, every ten minutes). A panel control module processes and renders the advertisement to be displayed on the electronic billboard.

If the content is approved by the screen owner, the advertiser is notified, and the content will then be eligible to be displayed on the digital billboard. In some embodiments, if the advertiser purchases another campaign and uses the same content on the same advertising panel the content will not need to be approved again. Upon the content being approved, the server transmits the approved content and the scheduling information to the panel control module associated with the digital billboard, which plays the ad according to the scheduling information.

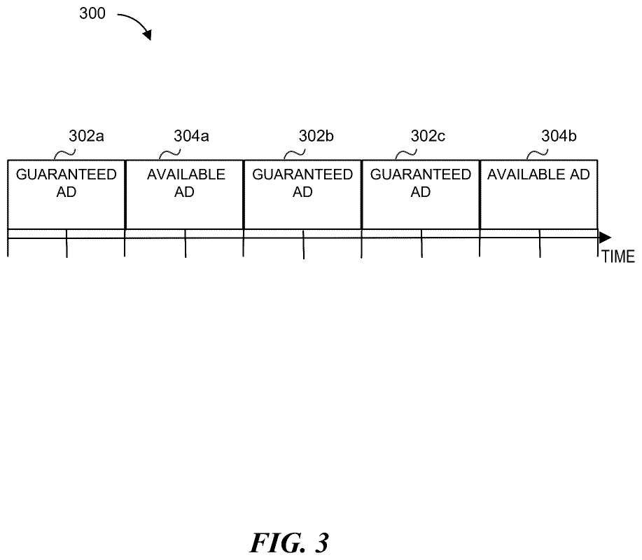

FIG. 3 is a block diagram of a process 300 for showing a series of advertisements on an OOH advertisement medium, in accordance with various embodiments. As noted above, an OOH advertising medium displays multiple advertisements at various time slots. As an example, a panel control module can render and display advertisements at predetermined durations (e.g., every ten seconds, every minute).

In some embodiments, the display of an advertisement is either ‘guaranteed’ (e.g., blocks 302a-c) or ‘as available’ (e.g., block 304a-b). In the guaranteed delivery method, the advertiser selects a specific number of time slots to display an advertisement.

Each time slot selected corresponds to an ad play (i.e., a unit of measurement of a time selected to display an advertisement). As an example, if the advertiser selects to display an advertisement at a frequency of “once every 4 minutes,” the advertisement is played once every 4 minutes on the OOH advertisement medium. Additionally, the guaranteed advertisement display method translates to a number of ad plays in the specified period and a price of the ad play that the advertiser can buy. After the advertiser purchases the ad plays, the availability of the digital billboard is updated on the online platform accordingly (e.g., the available ad plays for the panel is reduced by the number of ad plays bought the advertiser).

In the “if available” delivery method, the advertiser inputs a specified budget for displaying the advertisement, and the online platform identifies available time slots on the selected OOH advertisement medium that are available within the budget. In some embodiments, the advertiser gets a better price in the if available delivery method compared to the guaranteed delivery method, but the advertiser also ends up not getting any ad plays (e.g., if the inventory/time slots are not available for the digital billboard).

As shown in FIG. 3, a series of advertisements are scheduled to be displayed during various time blocks. For example, guaranteed ad 302a is scheduled to play for a first-time block, and an as available ad 304a is scheduled to be played during a second time block.

In some embodiments, to minimize or the avoid a scenario where the advertiser does not get any ad plays at all, the server implements a weighted algorithm to determine when to play the ads in the if available delivery method. In the weighted algorithm, after all the screen owner content has been scheduled and the advertiser content sold in a guaranteed delivery method is scheduled for the advertising panel, the server examines the schedule for the whole day and determines if there are any available slots in the schedule. If there any slots available, the server may start assigning a weight to the advertisers who purchased the slots in “if available” delivery method and displays the ads according to the weight.

As an example, a screen owner sets up a digital billboard with a 1-minute loop and a 6 second ad duration (which is the maximum time any single ad can play). This accounts for a total of 14,400 ad plays per day (24*60*(10 ad plays per minute)) for the digital billboard or 10 slots of 1,440 ad plays. The screen owner keeps 3 slots (that is, not make them available on the online platform) and schedules their own content in those 3 slots. The other 7 slots are sold on the online platform. One of the advertisers can buy 2 slots with the guaranteed delivery method. This leaves 5 slots, or 7,200 ad plays to be sold on an “if available” basis for that day. The server distributes those 5 slots among the advertisers that bought on an if available basis. For example, a first advertiser may buy 1,440 ad plays which equals 20% of the ad plays left, and a second advertiser buys 720 ad plays which equals 10% of the ad plays left. The first advertiser may schedule 4 pieces of content and the second advertiser schedules 1 piece of content on the digital billboard. The server may assign a weight to the content of the first advertiser as a function of the ad plays bought by the first advertiser and the number of content. For example, the server divides the 20% among the 4 contents of the first advertiser, which gives a weight of 5 to each of their content. Similarly, the server assigns a weight of 10 to the content of the second advertiser.

In this scenario, the server has not sold enough time slots to fill the left-over ad plays. The server takes all the screen owner, advertiser guaranteed and advertiser if available content and fills the left-over percentage (70% in this scenario) using the same percent left-over number of pieces of content calculation to obtain the weights. The server sends the content and the weights of the content to a panel control module associated with the digital billboard. In some embodiments, the higher the weight the more chances for the content to be displayed. Each time an unscheduled ad play comes up on the digital billboard, the panel control module randomly selects a piece of content to play.

The server adjusts the algorithm at a specified time interval (e.g., every 1-5 minutes), depending on the advertising panel settings, by calculating what got played and adjusting the weights of all the content. In some embodiments, the adjustment is done to evenly distribute an if available budget throughout the day so that the advertisers don't get all their ad plays first thing in the morning and then none for the rest of the day. Also, if the server oversells an advertising panel, the server can use an equal percentage of the budget of each of the advertisers instead of some advertisers getting all their budget spent and some getting none of their budget spent.

In some embodiments, the weighting algorithm is modified based on a variety of factors. The OOH advertising medium is be associated with a plurality of factors that impact the number of consumers that view the advertisement. Example factors include time of day, average consumers passing the panel, the size of the panel, etc. The weighting algorithm may give greater weight to providing advertisements during time slots that have more consumers viewing the panel. Accordingly, available time slots with more consumers viewing the panel have a greater price than other time slots with fewer consumers viewing the panel. In some embodiments, the algorithm considers other factors in determining the weight (e.g., spreading budget across a network of screens, hours of operation, geofenced campaigns, estimated ad plays, such as for a network like taxis where the number of ad plays per day are not known but estimated based on historical data).

In some embodiments, advertising panels on top of taxis or inside a vehicle include global positioning system (GPS) data that is made available to panel control modules. The panel control modules show ads based on campaign schedule, budget, os a geofence location (either inside or outside the specified geofences). The server uses the above algorithm to determine the weight if a content of the advertiser wins the ad play, and the panel control module then checks to make sure the advertising panel is within the specified geofence and shows or skips the ad accordingly. Weighting for geofence content may have a higher chance of being displayed and the algorithm uses historical data to determine the weighting for the geofence selections.

### AI Advertising Campaign Builder

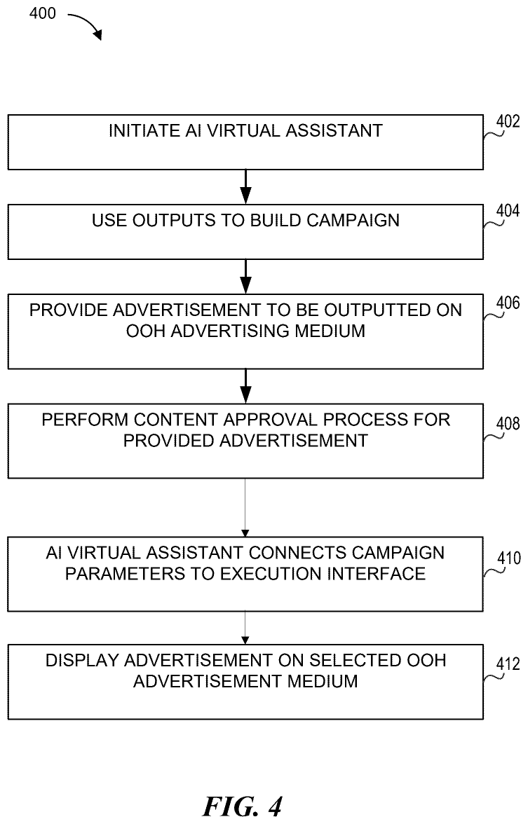

FIG. 4 is a flow diagram illustrating a process 400 for building an advertising campaign using an AI assistant, in accordance with various embodiments. As noted above, in embodiments of the present technology, a user interacts with a virtual assistant (402) to build an advertising campaign (404), including selection of an OOH advertising medium (e.g., panel) and scheduling display of marketing materials (e.g., an advertisement). Using the virtual assistant, many of the manual processes described with respect to FIG. 2 are automated or skipped entirely.

In some embodiments, the virtual assistant is integrated with the GUI of the online platform such that it automatically populates advertising parameters according to the AI output. The virtual assistant provides a link to a webpage of the online platform, where the finished advertising campaign is presented for review and approval on a graphical user interface (GUI). In some embodiments, the user has an account associated with the online platform, and the finished advertising campaign is added as a draft campaign to the account.

The virtual assistant is accessible at any stage in the process described in FIG. 2, such that the user manually performs some aspects of building the campaign, while the virtual assistant assists in other aspects. In some embodiments, GUI is the same as the GUI used for users to manually build the campaign. In some embodiments, the virtual assistant displays one or more potential OOH advertising media in a different interface, such as directly in the chat interface. While the user directly operates with a chat interface and perceives their own input as queries and prompts for the AI virtual assistant, the AI additionally receives hidden prompts and guidance based on the phase of operation that the campaign design sequence is in. The Hidden prompts are not shown to the user via the chat interface, but are included when submitted to the AI to frame or contextualize the user input.

The virtual assistant is configured to produce outputs to build an advertising campaign (404). Because generative AI models often produce open-ended outputs, prompts to the AI model must be structured in a manner that are productive toward building an advertising campaign.

One technique to improve responses to user prompts is called prompt engineering. With prompt engineering the assistant is configured to provide additional context to the prompts before further processing by the AI model. For example, if a user inputs a general query such as, “build me an ad campaign for my restaurant,” the AI model is configured with additional context that defines what is necessary for an ad campaign. For example, as described above, an OOH advertisement is associated with various parameters, such as budget, medium type, cost of time slots, etc., Accordingly, because building an OOH advertising campaign requires at least one OOH advertising medium, the assistant is configured to break down the query and solicit preferences for these parameters from the user. In another example, prompts are constrained to available inventory, so a query such as, “Suggest to me a billboard in Chicago” is interpreted by the model as “Return a billboard among available inventory in Chicago.” In a yet further example, a predesigned prompt is augmented by the user prompt along with additional context that defining what is necessary for an ad campaign. So, a query such as “Suggest to me a billboard in Chicago” is used to augment a predesigned query like “Identify a billboard among available inventory based on geofence data associated with a location,” resulting in a prompt to the model of “Identify a billboard among available inventor based on geofence data associated with Chicago.”

The virtual assistant seeks, through the chat interface, the answers to fill a plurality of parameters/fields associated with building an advertising campaign. To enable the chat interface to function in this manner, there are hidden queries applied to each user input (e.g., does the user's input include a value for any remaining needed parameters.) Rather than simply asking for each parameter one at a time, the virtual assistant is enabled to accept the values for multiple parameters at the same time as user's describe what they are looking for. Further, as some parameters are populated, some potential options are foreclosed, and thus the virtual assistant may suggest a particular set of values for those parameters that remain.

In another example, if the virtual assistant receives a prompt unrelated to advertising or previous messages, then the virtual assistant is configured to ask for more information or to redirect the conversation towards advertising. In some embodiments, the AI model is trained with a list of prohibited topics to identify impermissible queries.

In some embodiments, the virtual assistant is built using a customized version of an existing LLM model. In addition to the training performed to develop the underlying model, the AI model for the virtual assistant is trained on a set of data specialized for advertising campaigns. For example, OOH media inventory data, including location of media, type of media (e.g., billboard, taxi, etc.), cost, indoor/outdoor screens, venue type, screen orientation, screen size, media owner, etc., are used to train the model. Example venues include:
Airport
Airport Lounge
Apartment Building
Bar/Restaurant Jukebox
Bar/Restaurant TV
Bowling Alley
Cannabis Dispensary
Casual Dining
Cinema (In-Theater)
Cinema (Lobby)
College Campus
Convenience Store
Dental Clinic
Digital Billboard.
Doctors Office
Gas Station
Grocery Store
Gym
Hotel
Liquor/Wine/Beer Store.
Mobile Billboard: LED screens on sides and rear of trucks traveling through city streets.
Office Building
Indoor Businesses
Parking Garage
Pharmacy/Drugstore
Quick Service Restaurant
Retail
Salon (Men)
Salon (Women)
Shopping Mall
Spectacular: Larger-than-life digital screens located in iconic locations.
Sports Entertainment
Subway
Taxi/Rideshare Interior
Taxi/Rideshare Top
Train Station
Transit Shelter
Urban Panel
Veterinarian Clinic

The virtual assistant uses these data to determine relationships between parameters and suggest OOH media. For example, if a large billboard with strong performance metrics becomes available at lower price than comparable billboards, or at a historically low price, the virtual assistant is able to identify the billboard as a good value and suggest it to the user.

Historical advertising data is also used to train the model, such as scheduling (e.g., time slot data), prices, product/service being advertised, type of content, venue combination, and performance metrics associated with the advertisement (e.g., impressions, effective cost per mile, changes in foot-traffic or website visitation, etc.). In addition, the AI model is trained to suggest combinations of OOH media based on various parameters. For example, the training data may indicate that performance per dollar is increased when advertisements are divided among certain combinations of media (e.g., 50% billboard, 20% gas station, 30% taxi). Furthermore, in some embodiments, feedback, such as user feedback or performance analysis, is provided to the AI model for advertising campaigns produced by the AI model, which is then used to iteratively improve performance of the mode.

Location data, demographics, foot-traffic, vehicle traffic, etc., are also relevant training data, especially in conjunction with market and census data for various product/service categories. For example, if an advertiser asks the virtual assistant to find OOH media for advertising children's shoes, the AI model will consider whether parents with children are likely to view the OOH media in a given area based on population data. In addition, the virtual assistant is trained to suggest a target audience and compose detailed advertising strategy and tactics. For example, the virtual assistant will assist the user in identifying sales and advertising goals, such as building brand awareness, targeting certain demographics, assessing competition, determining supplemental advertisements (e.g., influencers or social media), and building an OOH advertising campaign accordingly. For example, the virtual assistant will ask, “What are your advertising goals?” or derive goals from similar advertisers determined through the training data.

LLMs are well-known to produce hallucinations, where the LLM confidently produces incorrect outputs based on its training data. To improve the reliability and accuracy of responses, the virtual assistant is implemented by supplementing the AI model with external data, for example, using retrieval-augmented generation (RAG). Specifically, queries to the AI model are sent to a separate model that converts to the query to a numeric format, e.g., a vector. The vector is compared to indices of the knowledge base, and matching information is input into the AI model. This information is combined with the responses generated by the AI model to the original query to ensure that the response presented to the user is accurate or presented with citations.

Example knowledge bases for implementing RAG include updated OOH media inventory (including associated pricing data, size, and other properties as described elsewhere), market data, and social media trends (e.g., TikTok, Instagram, YouTube, etc.). By cross-referencing responses with existing inventory, the virtual assistant is less likely to suggest OOH advertising media that is unavailable or does not exist. In addition, panel owners have different preferences or restrictions regarding the type and format of advertising content, which may prevent an otherwise suitable OOH media from being suggested by the AI model. The knowledge bases used for implementing RAG are continually updated. For example, the available inventory of OOH media is automatically updated as users build and launch advertising campaigns, and panel owners join or leave the online platform.

After the advertising campaign is built, the advertising content is provided at step 406. The advertising content includes images, video, or music. Advertising content is uploaded manually from the user's, pulled from third-party sources (e.g., social media), or generated using AI using the virtual assistant.

The panel owner then approves the advertising content at step 408. In some embodiments, the approval process is similar as described above with reference FIG. 2. In some embodiments, the virtual assistant is trained to determine whether or not advertising content is likely to be approved, for example using historical content and approval data. The virtual assistant then approves or denies content automatically, or on a preliminary basis for further review by the panel owner.

In step 410, once content approval has been received by the AI virtual assistant, the campaign parameters are passed to an execution platform automatically, and the same graphic user interface (e.g., the chat interface) is repurposed into a confirmation and execution interface. In shifting interface phases or stages, the hidden query prompts of the AI virtual assistant (that direct the manner in which the chat interface interprets the user input) also change. Those prompts shift from seeking to fill out parameters and obtain approval for campaign content to identifying approval for the executing the campaign. The hidden prompts identify OOH medium owners to connect approved campaign materials to.

In step 412, following approval by the user and the medium owner, the advertisement is displayed according to the parameters associated with the ad campaign built at step 404.

### Online Platform GUIs

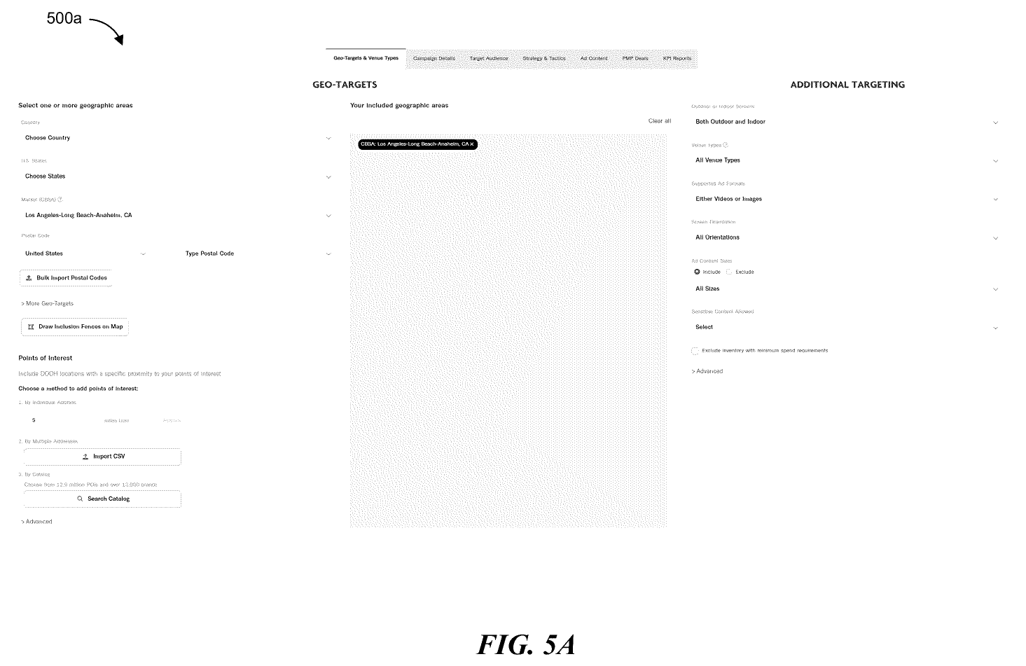

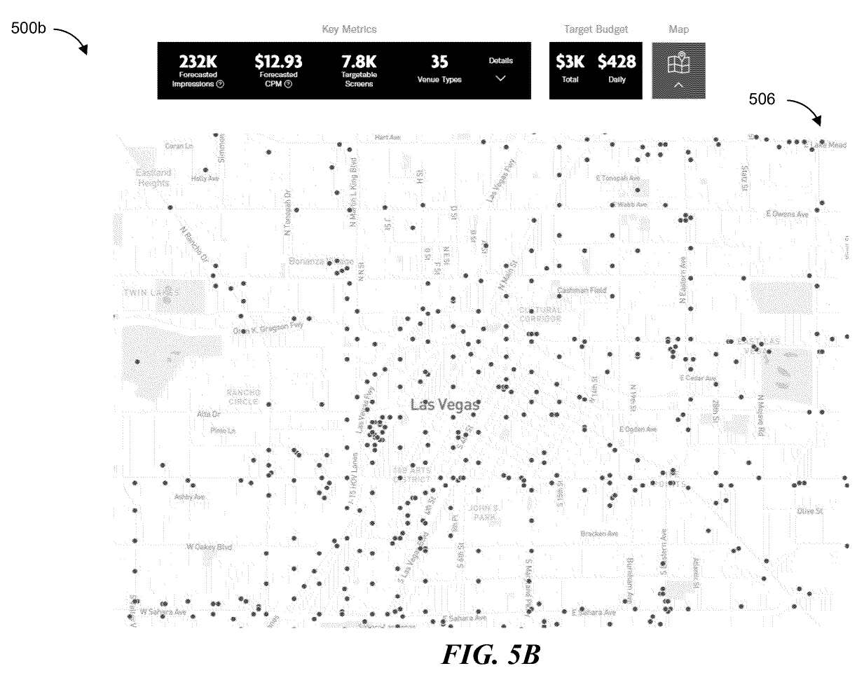

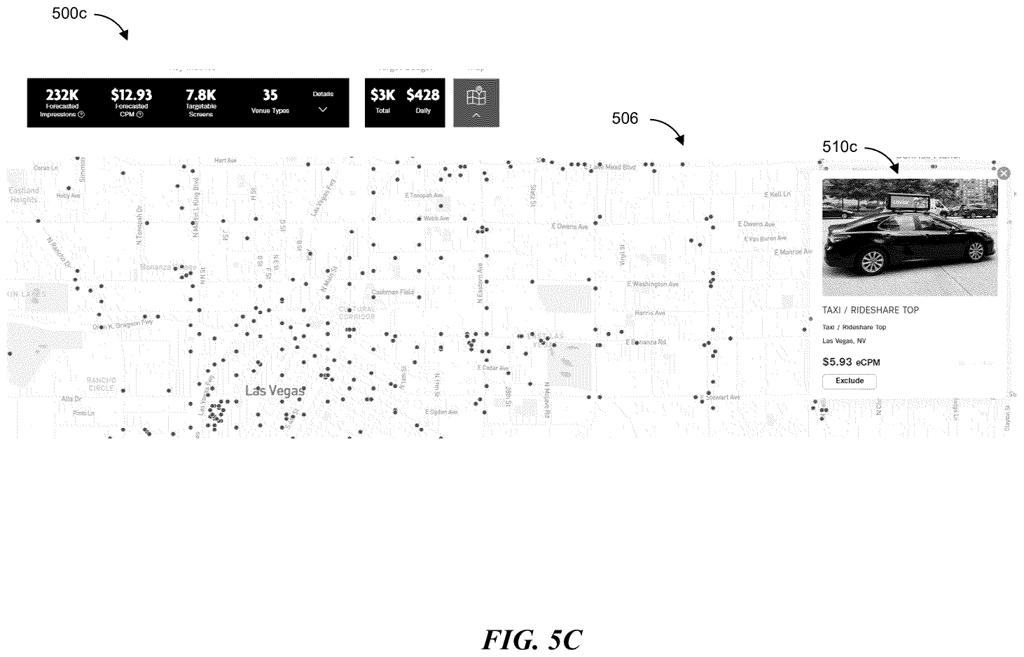

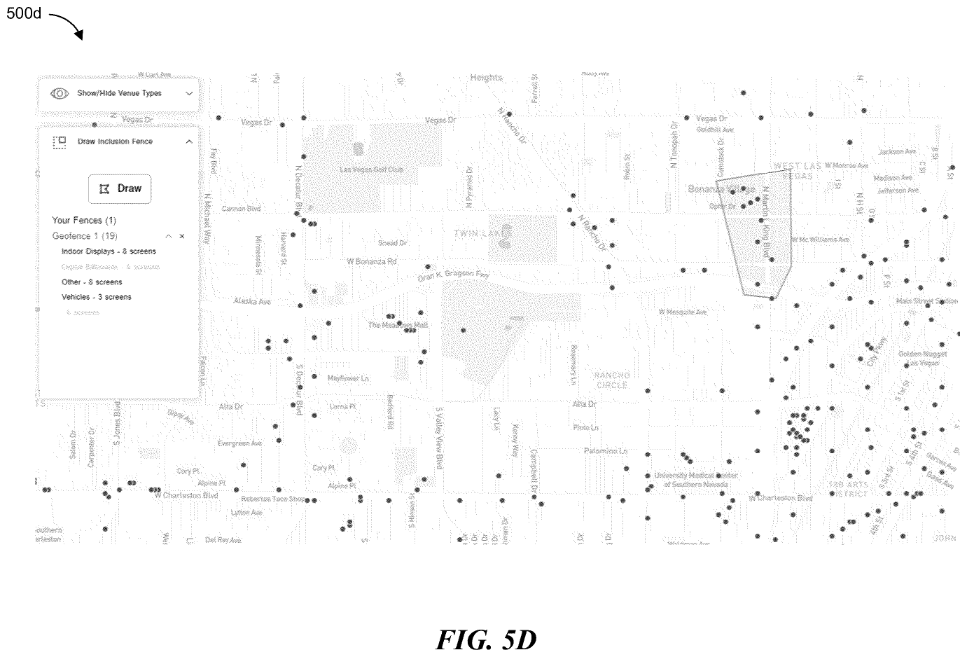

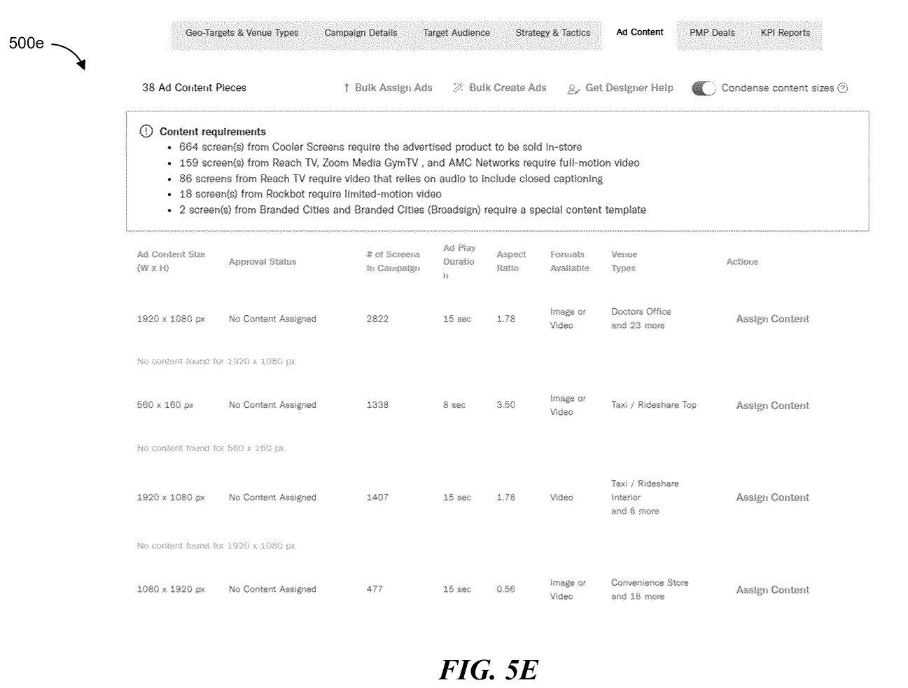

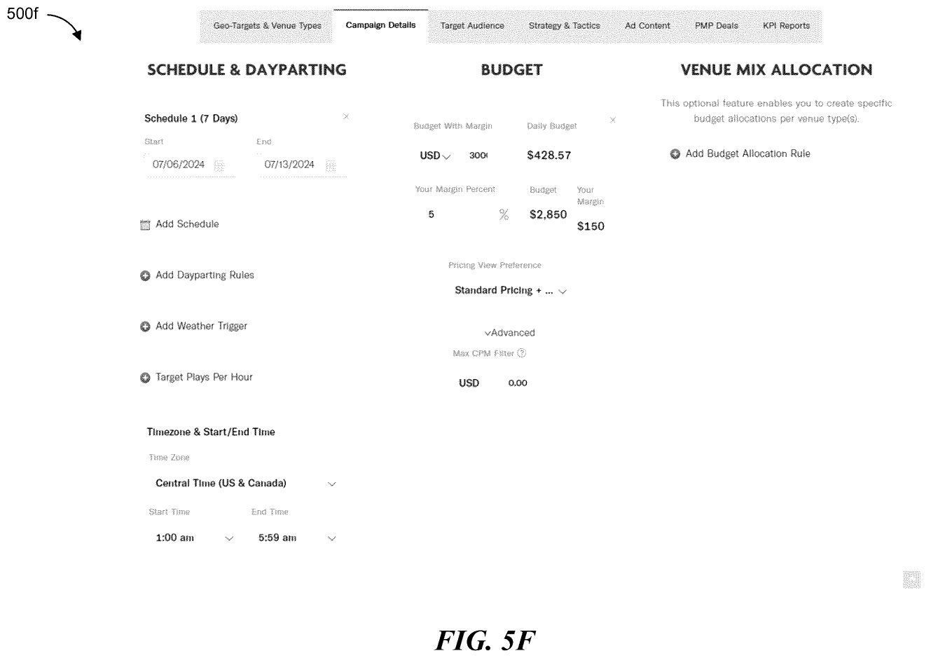

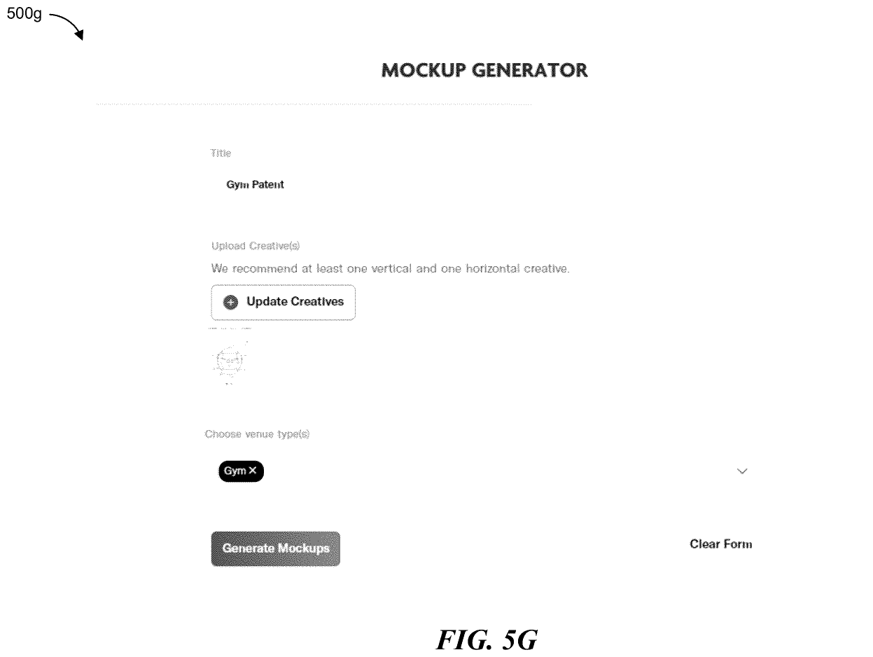

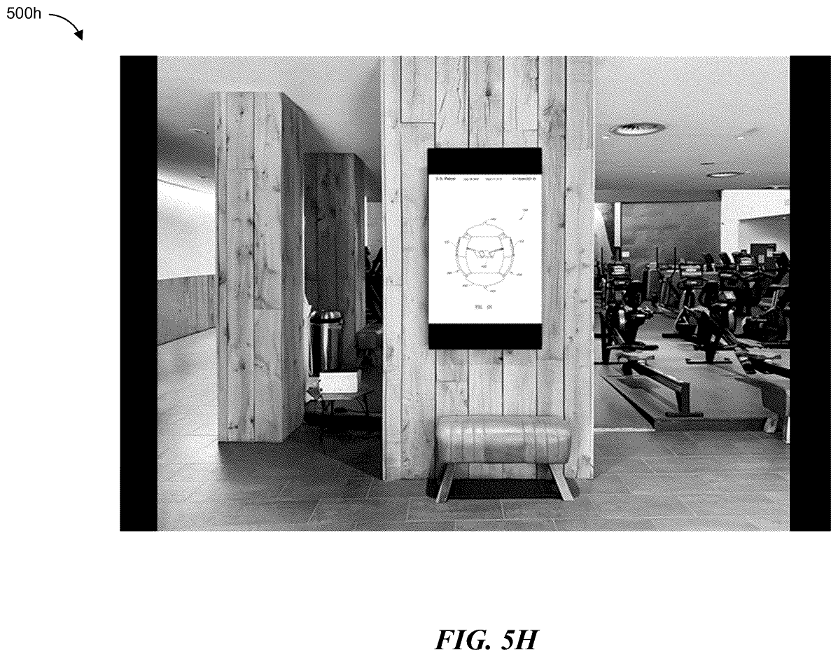

FIGS. 5A-5H are example GUIs for searching for advertising panels and submitting ad content for displaying in an advertising panel, in accordance with various embodiments. The server generates various GUIs that are interacted with by a screen owner to register their advertising panel in the online platform. In some embodiments, the virtual assistant is available at any stage of searching or submitting ad content to continue the process after the user performs steps using the various GUIs.

Once registered, the online platform makes the advertising panel available for the advertisers to display their ads. As part of the registration process, the screen owner provides various details of the advertising panel, such as scheduler type, support level, start date, display type, size (e.g., in feet), number of faces, facing direction, advertising panel name, advertising panel ID, advertising panel location, hours of operation, description, height and width (e.g., in pixels), start player full screen, content type allowed, rotate content, additional content guidelines, and name of the entity who should approve ad content.

Below are example terminologies that may be used in managing an advertising panel. A first term may include loop, which may indicate a number of minutes to break a number of advertisements to be played in a sequence on the panel. Another term may be an ad duration, which may be a number of seconds a piece of content stays on the screen before switching to the next piece of content. In some embodiments, the ad duration may be evenly divisible by the number of seconds in the loop. For example, for a 2-minute loop length, the ad duration can be 5, 6, 7, 8, 10, 12, 15, 20, 24, 30, 40, 60, 120. Another term may be slots, which may indicate a loop length in seconds divided by the ad duration. For example, a 2-minute loop equals 120 seconds, with an ad duration of 6 seconds that gives 20 slots (120/6).

FIG. 5A is a screenshot of a search GUI 500a used for searching the online platform for advertising panels, in accordance with various embodiments. In the search GUI, a user (e.g., the advertiser), inputs search criteria such as a city or zip code of a location where the advertiser would like to search for advertising panels. For example, the advertiser can input the city as Las Vegas, NV. However, any number of search criteria may be included in the search GUI 500a.

FIG. 5B is a screenshot of a search result GUI 500b showing a search result having a map of advertising panels, in accordance with various embodiments. In the search result GUI 500b, the server displays information regarding advertising panels that satisfies the search criteria. The information in the search results can include an image of an advertising panel, cost per ad play for the advertising panel, and a location of the advertising panel. The search result GUI 500b also shows a location of the advertising panels in the list using a map 506. Further, the previous search GUI 500a is accessible and allows the advertiser to further update the search result by updating one or more search criterion (e.g., type of advertising panel). The advertiser can select one of the advertising panels (e.g., digital billboard), to view additional information associated with the selected advertising panel.

FIG. 5C is a screenshot of a GUI 500c showing information associated with an advertising panel selected from a search result, in accordance with various embodiments. In some embodiments, the GUI 500c shows information regarding other associated advertising panels (e.g., advertising panels that are near by the taxi cab panel 510c). The GUI 500c may also include detailed information relating to the selected panel 510c, such venue type, performance metrics, etc.

FIG. 5D is a screenshot of a GUI 500d showing a geofence, in accordance with various embodiments. The geofence narrows the advertising campaign within the geofenced area. The geofence is provided by the user via mouse or touchscreen input to the user device. The GUI includes an information panel that provides further detail regarding the number of OOH displays and venue types of the displays in the geofenced area.

FIG. 5E is a screenshot of an upload GUI 500e for uploading ad content, in accordance with various embodiments. In the upload GUI, the advertiser uploads the ad content to be displayed on the digital billboard in by clicking an “Assign Content” link. The advertiser can upload the content from one or sources, such as from the client device associated with the advertiser, or a cloud storage service. The ad content upload GUI also displays the types of ad content supported by the digital billboard, along with requirements from owners of the billboards.

FIG. 5F is a screenshot of a GUI 500f for scheduling and budgeting ad campaigns, in accordance with various embodiments. In the GUI 500f, the advertiser sets scheduling rules of specifies a budget, for example to set “guaranteed” or “as available” ad scheduling.

FIG. 5G is a screenshot of a mockup generator GUI 500g, in accordance with various embodiments. In the GUI 500g, the advertiser simulates an advertisement in a selected venue type. The advertiser uploads an image or video from their device or imports from a website or cloud storage. An example output 500h is shown in FIG. 5H, showing an advertising image simulated in on an OOH display located in a gym.

### OOH Advertising Medium Management

The server provides inventory management systems for managing the advertising panels. In a guaranteed scheduling type/inventory management system, the screen owner chooses their loop length and ad duration, which the server uses to determine the number of total slots. The screen owner chooses the number of slots they would like to sell on the online platform. The online platform facilitates selling and scheduling down to a single ad play for a specific date and time of day from the number of slots.

Some screen owners may not want to manage down to the minute and would rather have a playlist. In a playlist scheduling type, the screen owner defines an ad duration and rotate through all their scheduled content until the online platform reaches the end, and then starts over. The screen owner specifies what percentage of the ad plays they want to sell on the online platform, or the default is to prioritize paid ad plays. Accordingly, if there are a sufficient number of advertisers, the screen owner's content may not play at all.

In some embodiments, the screen owner creates events with a start and an end dates/times and an ad duration. From this, the server calculates how many ad plays there are that can be sold and what percent the screen owner wants to sell. The server lets the advertiser select one or more events, how many ad plays they want to buy for each event, and schedules content on a per event basis. In some embodiments, the events scheduling type are most commonly used for sporting events or concerts, and the ad plays are listed for sale in a list of events (such as individual baseball games).

The server may include a monitoring component, which monitors the online platform and alerts the admin user, advertiser and/or the advertising panel owner in case of an occurrence of one or more events. For example, the monitoring component monitors the working of an advertising panel, and in an event the advertising panel is faulty (e.g., the advertising panel is not working or otherwise not being able to display the ad), the monitoring component alerts any of the admin user, advertising panel owner or the advertisers whose ads are to be displayed on the advertising panel.

The server may include a reporting component that generates a number of reports for any of an administrative user, advertising panel owner, or the advertiser. In some embodiments, for an advertiser, the reporting component generates a report such as proof of play, campaign summary, accounting or payments. The proof of play report includes information such as number of ad content played, total number of ad plays, total number of impressions delivered (e.g., number of target audience). The campaign summary provides information such as total amount spent by the advertiser for the campaigns, total ad time, total number of impressions delivered, etc.

For a screen owner, the reporting component generate reports such as the above reports generated for the advertiser, but from the perspective of one or more advertising panels of the screen owner, and other reports such as payouts, collected revenue, license payments, accounting, or occupancy. In some embodiments, the occupancy report includes information such as total number of slots of an advertising panel displaying the ads, a number of slots occupied by the screen owner content, and a number of slots occupied by the advertiser content.

Note that the above reports are highly customized by the user. For example, the proof of play report is generated by the advertiser per advertising panel, a set of advertising panels displaying a specific ad, all advertising panels, for a specific day, etc.

The server may include an audience measurement component that is used to generate audience data (e.g., demographics, interests/behaviors, etc.) for the locations of the advertising panels. Such audience data is used to help advertisers to plan and buy inventory based on target audience and provide post-campaign reporting on the audience reached. In some embodiments, the server communicates with third-party systems to obtain at least a portion of the audience data. The third-party systems employs one or more sensors (e.g., near the advertising panels, to obtain the audience data.

In some embodiments, the audience measurement component and/or the third-party systems obtain audience data using mobile device data. The mobile device data includes location audience data from mobile devices via apps (e.g., first party SDKs) or at exchanges (e.g., bitstream). The location audience data is combined with census or survey data using the computed home locations of devices.

In some embodiments, the audience measurement component and/or the third-party systems obtains audience data using cameras. Example information gathered using cameras can include video feed analyzed by software that captures impressions and an ad duration.

In some embodiments, the audience measurement component and/or the third-party systems obtains audience data using Wi-Fi sniffing that tracks the presence of devices as proxy for headcount and ad duration. The Wi-fi sniffing capture impressions and ad duration or a frequency of visits.

In some embodiments, the audience measurement component and/or the third-party systems obtains audience data by the screen owner. Screen owner information classifies the audience based on type of location (e.g., a coffee shop) using information such as a purchase history or other proprietary info from the screen owner. The screen owner information includes a custom taxonomy.

In some embodiments, the audience measurement component and/or the third-party systems obtains audience data by a census and other public records.

In some embodiments, the audience measurement component and/or the third-party systems obtains audience data using social media posts tagged with a location. The server determines behavior and interest using text analysis of social media posts tagged by location, which gives unique insights into behavior personas.

Example audience data attributes that are determined using the above sources can include demographics (e.g., as age range, gender, ethnicity, family number of children, parent, elderly present in home, empty nester, etc.) homeowner status, household income, job function, length of residence, behavior or interests (e.g., fast casual diners, high-end grocery customer, football fans, brand shoppers, etc.).

In some embodiments, the audience data gleaned from such sources are used by the server to help the advertisers to buy inventory based on target audience. For example, if the advertisers want to target the ad to audience based on their purchase history (e.g., the server can recommend advertising panels based on the data obtained from screen-owner provided data source). In another example, if the advertisers want to target the ad to audience based on their affluence, the server recommends advertising panels in locations where cars of one or more brands are seen to be driven more than other locations, which are determined by analyzing video feed from video cameras installed near the advertising panels for specified brand of cars. In another example, if the advertisers want to target the ad to audience for certain age groups, the server recommends advertising panels in locations having people of those age groups, which can be determined based on mobile device data and/or census and other public records.

The audience data is used to score the advertising panels, determine a percentage match (composition of target audience) for a specified advertising panel, sort advertising panels by “Best Match” (e.g. score or percentage match, determine audience weighted cost per mile/thousand (CPM), allow advertiser to specify budget, or target visitor frequency and filtering list of advertising panels accordingly, generate potential reach vs. budget interactive chart, or ability to bulk-select advertising panels (e.g., add to cart) from the search results (e.g., after filtering by audience).

In some embodiments, the scoring/sorting (“scoring”) algorithm for generating a score for the advertising panels considers one or more factors, such as location (e.g., state, zip, DMA, custom geofence), selected audience (e.g., demographics, behaviors, interests, brand shoppers), ad play price, budget, frequency of ad play, impressions, CPM (e.g., using ad play price+impressions), ad duration, or visit frequency (e.g. average number of times a visitor had Opportunity To See (OTS) per week). Note that in various embodiments, any of these audience data and measurements are implemented using the virtual assistant, for example using audience, location, and census data in the training data for the AI model.

### Mobile Device Advertising Material Display

In some embodiments, the online platform facilitates the selection of advertisements to be displayed on mobile applications (or ‘apps’) executing on mobile devices. For example, the advertisers choose their OOH advertising pane locations, and the server may create an exposure area around the OOH advertising panel (e.g., a quarter-mile radius).

The server tags any mobile devices that pass through the exposure area in the storage system and then deliver ads (e.g., from mobile ad serving partners) as a complement to the larger OOH advertising panels. The advertisers is able to track performance and generate reports for both the physical OOH advertising panels and the mobile devices.

### Computing Platform

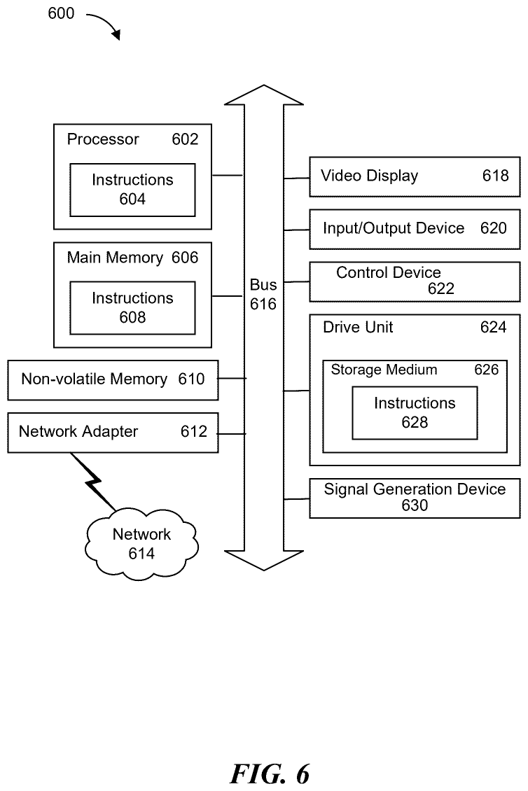

FIG. 6 is a block diagram illustrating an example computer system 600, in accordance with one or more embodiments. In some embodiments, components of the example computer system 600 are used to implement the software platforms described herein. At least some operations described herein can be implemented on the computer system 600.

In some embodiments, the computer system 600 includes one or more central processing units (“processors”) 602, main memory 606, non-volatile memory 610, network adapters 612 (e.g., network interface), video displays 618, input/output devices 620, control devices 622 (e.g., keyboard and pointing devices), drive units 624 including a storage medium 626, and a signal generation device 630 that are communicatively connected to a bus 616. The bus 616 is illustrated as an abstraction that represents one or more physical buses and/or point-to-point connections that are connected by appropriate bridges, adapters, or controllers. The bus 616, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 794 bus (also referred to as “Firewire”).

In some embodiments, the computer system 600 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 600.

While the main memory 606, non-volatile memory 610, and storage medium 626 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 628. The term “machine-readable medium” and “storage medium” shall also be taken to include any medium that is capable of storing, encoding, or carrying a set of instructions for execution by the computer system 600. In some embodiments, the non-volatile memory 610 or the storage medium 626 is a non-transitory, computer-readable storage medium storing computer instructions, which is executable by the one or more “processors” 602 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in a computer device. When read and executed by the one or more processors 602, the instruction(s) cause the computer system 600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 610, floppy and other removable disks, hard disk drives, optical discs (e.g., compact disc read-only memory (CD-ROMS), digital versatile discs (DVDs)), and transmission-type media such as digital and analog communication links.

The network adapter 612 enables the computer system 600 to mediate data in a network 614 with an entity that is external to the computer system 600 through any communication protocol supported by the computer system 600 and the external entity. The network adapter 612 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 612 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

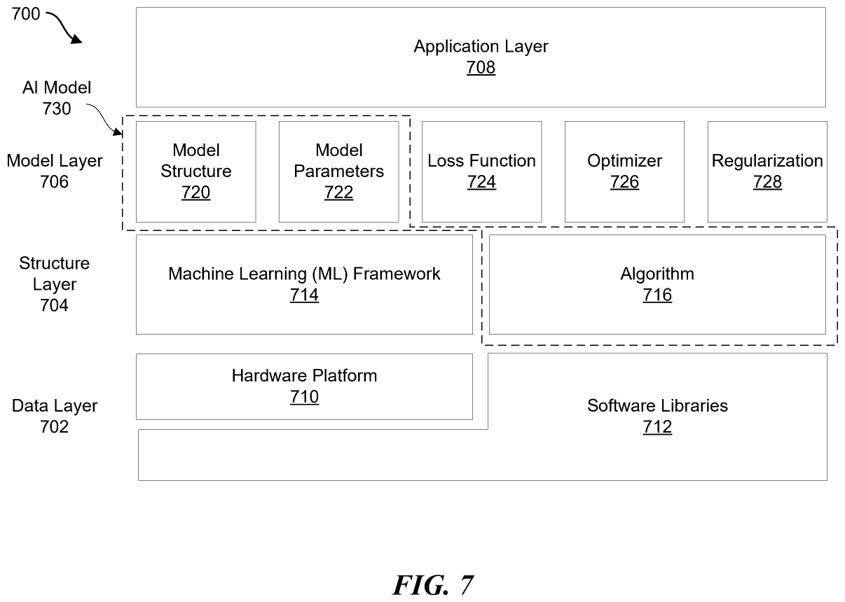

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example AI system 700 illustrated and described in more detail with reference to FIG. 7.

### AI System

FIG. 7 is a high-level block diagram illustrating an example AI system, in accordance with one or more embodiments. The AI system 700 is implemented using components of the example computer system 600 illustrated and described in more detail with reference to FIG. 6. Likewise, embodiments of the AI system 700 include different and/or additional components or be connected in different ways.

In some embodiments, as shown in FIG. 7, the AI system 700 includes a set of layers, which conceptually organize elements within an example network topology for the AI system's architecture to implement a particular AI model 730. Generally, an AI model 730 is a computer-executable program implemented by the AI system 700 that analyses data to make predictions. Information passes through each layer of the AI system 700 to generate outputs for the AI model 730. The layers include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for the application of the AI model 730 by the application layer 708.

The data layer 702 acts as the foundation of the AI system 700 by preparing data for the AI model 730. As shown, in some embodiments, the data layer 702 includes two sub-layers: a hardware platform 710 and one or more software libraries 712. The hardware platform 710 is designed to perform operations for the AI model 730 and includes computing resources for storage, memory, logic, and networking, such as the resources described in relation to FIG. 6. The hardware platform 710 processes amounts of data using one or more servers. The servers can perform backend operations such as matrix calculations, parallel calculations, machine learning (ML) training, and the like. Examples of servers used by the hardware platform 710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 710 includes Infrastructure as a Service (IaaS) resources, which are computing resources, (e.g., servers, memory, etc.) offered by a cloud services provider. In some embodiments, the hardware platform 710 includes computer memory for storing data about the AI model 730, application of the AI model 730, and training data for the AI model 730. In some embodiments, the computer memory is a form of random-access memory (RAM), such as dynamic RAM, static RAM, and non-volatile RAM.

In some embodiments, the software libraries 712 are thought of as suites of data and programming code, including executables, used to control the computing resources of the hardware platform 710. In some embodiments, the programming code includes low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource's instruction set architecture, allowing them to run quickly with a small memory footprint. Examples of software libraries 712 that can be included in the AI system 700 include Intel Math Kernel Library, Nvidia cuDNN, Eigen, and Open BLAS.

In some embodiments, the structure layer 704 includes an ML framework 714 and an algorithm 716. The ML framework 714 can be thought of as an interface, library, or tool that allows users to build and deploy the AI model 730. In some embodiments, the ML framework 714 includes an open-source library, an application programming interface (API), a gradient-boosting library, an ensemble method, and/or a deep learning toolkit that works with the layers of the AI system facilitate development of the AI model 730. For example, the ML framework 714 distributes processes for the application or training of the AI model 730 across multiple resources in the hardware platform 710. In some embodiments, the ML framework 714 also includes a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730. Examples of ML frameworks 714 that can be used in the AI system 700 include TensorFlow, PyTorch, Scikit-Learn, Keras, Caffe, LightGBM, Random Forest, and Amazon Web Services.

In some embodiments, the algorithm 716 is an organized set of computer-executable operations used to generate output data from a set of input data and can be described using pseudocode. In some embodiments, the algorithm 716 includes complex code that allows the computing resources to learn from new input data and create new/modified outputs based on what was learned. In some implementations, the algorithm 716 builds the AI model 730 through being trained while running computing resources of the hardware platform 710. The training allows the algorithm 716 to make predictions or decisions without being explicitly programmed to do so. Once trained, the algorithm 716 runs at the computing resources as part of the AI model 730 to make predictions or decisions, improve computing resource performance, or perform tasks. The algorithm 716 is trained using supervised learning, unsupervised learning, semi-supervised learning, and/or reinforcement learning.

The application layer 708 describes how the AI system 700 is used to solve problems or perform tasks. In an example implementation, the application layer 708 is used to build campaigns as described with reference to FIG. 4.

As an example, to train an AI model 730 that is intended to model human language (also referred to as a language model), the data layer 702 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 702 is annotated with ground truth labels (e.g., each data entry in the training dataset is paired with a label), or unlabeled.

Training an AI model 730 generally involves inputting into an AI model 730 (e.g., an untrained ML model) data layer 702 to be processed by the AI model 730, processing the data layer 702 using the AI model 730, collecting the output generated by the AI model 730 (e.g., based on the inputted training data), and comparing the output to a desired set of target values. If the data layer 702 is labeled, the desired target values, in some embodiments, are, e.g., the ground truth labels of the data layer 702. If the data layer 702 is unlabeled, the desired target value is, in some embodiments, a reconstructed (or otherwise processed) version of the corresponding AI model 730 input (e.g., in the case of an autoencoder), or is a measure of some target observable effect on the environment (e.g., in the case of a reinforcement learning agent). The parameters of the AI model 730 are updated based on a difference between the generated output value and the desired target value. For example, if the value outputted by the AI model 730 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 730 typically is to minimize a loss function or maximize a reward function.

In some embodiments, the data layer 702 is a subset of a larger data set. For example, a data set is split into three mutually exclusive subsets: a training set, a validation (or cross-validation) set, and a testing set. The three subsets of data, in some embodiments, are used sequentially during AI model 730 training. For example, the training set is first used to train one or more ML models, each AI model 730, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 730. Backpropagation is used to adjust (also referred to as update) the value of the parameters in the AI model 730, with the goal of optimizing the objective function. For example, a defined loss function is calculated by forward propagation of an input to obtain an output of the AI model 730 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 730 are used. The process of updating (or learning) the parameters over many iterations is referred to as training. In some embodiments, training is carried out iteratively until a convergence condition is met (e.g., a predefined maximum number of iterations has been performed, or the value outputted by the AI model 730 is sufficiently converged with the desired target value), after which the AI model 730 is considered to be sufficiently trained. The values of the learned parameters are then fixed and the AI model 730 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 730 typically involves further training the ML model on a number of data samples (which may be smaller in number/cardinality than those used to train the model initially) that closely target the specific task. For example, an AI model 730 for generating natural language that has been trained generically on publicly available text corpora is, e.g., fine-tuned by further training using specific training samples. In some embodiments, the specific training samples are used to generate language in a certain style or a certain format. For example, the AI model 730 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A system for building an out of home (OOH) media content campaign comprising:
a platform configured to identify particular OOH media content mediums of a plurality of OOH media content mediums via a selection of one or more parameters of a plurality of parameters associated with the plurality of OOH media content mediums;
a datastore, the datastore accessible by the platform and including data associated with the plurality of OOH media content mediums; and
a virtual assistant hosted by the platform, the virtual assistant configured to:
receive a user input associated with the OOH media content campaign;
modify via prompt engineering a virtual assistant query based on the user input and data from the datastore, wherein the data augments a predesigned prompt with information associated with building the OOH media content campaign;
transmit the virtual assistant query to an artificial intelligence (AI), the AI is trained to identify the one or more parameters of the plurality of parameters associated with the plurality of OOH media content mediums;
receive, from the AI, a response to the virtual assistant query indicating the one or more parameters of the plurality of parameters associated with the plurality of OOH media content mediums;
select, based on the response, the one or more parameters of the plurality of parameters; and
cause the platform to identify the particular OOH media content mediums.

2. The system for building the out of home (OOH) media content campaign of claim 1, wherein the plurality of parameters associated with the plurality of OOH media content mediums are characteristics of the OOH media content campaign further comprising:
an OOH media content campaign target location;
an OOH media content campaign target audience;
an OOH media content campaign budget;
an OOH media content campaign ad play price;
an OOH media content campaign ad play frequency;
an OOH media content campaign duration; or
an OOH media content campaign medium type.

3. The system for building the out of home (OOH) media content campaign of claim 1, wherein the data associated with the plurality of OOH media content mediums further comprises:
a medium type of the plurality of OOH media content mediums;
an availability of the plurality of OOH media content mediums;
a performance metric of the plurality of OOH media content mediums;
an audience of the plurality of OOH media content mediums;
a location of the plurality of OOH media content mediums;
a price of the plurality of OOH media content mediums; or
an owner of the plurality of OOH media content mediums.

4. The system for building the out of home (OOH) media content campaign of claim 3, wherein the medium type of the plurality of OOH media content mediums comprises one or more of:
a digital billboard;
a mobile display;
a public electronic panel; or
a vehicle advertisement panel.

5. The system for building the out of home (OOH) media content campaign of claim 1, wherein the user input comprises:
a natural language text;
an attachment;
an image; or
a video.

6. The system for building the out of home (OOH) media content campaign of claim 1, wherein the virtual assistant is further configured to:
in response to receiving the user input, generate a reply to the user input, the reply requesting a second user input;
receive the second user input, the second user input based on the reply; and
modify via prompt engineering the virtual assistant query based on the user input, the second user input, and data from the datastore, wherein the data augments a predesigned prompt with information associated with building the OOH media content campaign.

7. The system for building the out of home (OOH) media content campaign of claim 1, the system further comprising:
a graphical user interface (GUI) of the platform; and
the platform further configured to:
receive a media content from a user, wherein the media content is one or more of a video, a text, an image, or an audio;
generate, based on the media content, a mock-view of an OOH media content medium of the identified particular OOH media content mediums, wherein the mock-view includes the media content from the user; and
display, at the GUI of the platform, the mock-view.

8. A system for building an out of home (OOH) media content campaign comprising:
a platform configured to identify particular OOH media content mediums of a plurality of OOH media content mediums via a selection of one or more parameters of a plurality of parameters associated with the plurality of OOH media content mediums;
a datastore, the datastore accessible by the platform and including data, the data including characteristics of the plurality of OOH media content mediums, wherein the data of the datastore is categorized by association with the plurality of parameters;
a graphical user interface (GUI) of the platform, the GUI configured to receive a user input associated with the OOH media content campaign and to display a graphical representation of the OOH media content campaign; and
a virtual assistant hosted by the platform, the virtual assistant configured to:
modify via prompt engineering a predesigned prompt based on the user input received at the GUI and data from the datastore;
transmit the modified predesigned prompt to an artificial intelligence (AI), the AI is trained to identify the one or more parameters of the plurality of parameters associated with the plurality of OOH media content mediums;
receive, from the AI, a response to the modified predesigned prompt indicating the one or more parameters of the plurality of parameters associated with the plurality of OOH media content mediums;
select, based on the response, the one or more parameters of the plurality of parameters; and
cause the GUI to display the particular OOH media content mediums identified by the platform based on the selection of the one or more parameters of the plurality of parameters.

9. The system for building the out of home (OOH) media content campaign of claim 8, wherein the plurality of parameters associated with the plurality of OOH media content mediums are characteristics of the OOH media content campaign further comprising:
an OOH media content campaign target location;
an OOH media content campaign target audience;
an OOH media content campaign budget;
an OOH media content campaign ad play price;
an OOH media content campaign ad play frequency;
an OOH media content campaign duration; or
an OOH media content campaign medium type.

10. The system for building the out of home (OOH) media content campaign of claim 8, wherein the data associated with the plurality of OOH media content mediums further comprises:
a medium type of the plurality of OOH media content mediums;
an availability of the plurality of OOH media content mediums;
a performance metric of the plurality of OOH media content mediums;
an audience of the plurality of OOH media content mediums;
a location of the plurality of OOH media content mediums;
a price of the plurality of OOH media content mediums; or
an owner of the plurality of OOH media content mediums.

11. The system for building the out of home (OOH) media content campaign of claim 10, wherein the medium type of the plurality of OOH media content mediums comprises one or more of:
a digital billboard;
a mobile display;
a public electronic panel; or
a vehicle advertisement panel.

12. The system for building the out of home (OOH) media content campaign of claim 8, wherein the user input received at the GUI comprises:
a natural language text;
an attachment;
an image; or
a video.

13. The system for building the out of home (OOH) media content campaign of claim 8, wherein the virtual assistant is further configured to:
generate a reply to the user input, the reply requesting a second user input;
cause the GUI to display the reply, the GUI configured to receive the second user input; and
modify via prompt engineering the predesigned prompt based on the user input received at the GUI, the second user input received at the GUI, and data from the datastore.

14. The system for building the out of home (OOH) media content campaign of claim 8, the system further comprising:
the platform further configured to:
receive a media content from a user, wherein the media content is one or more of a video, a text, an image, or an audio;
generate, based on the media content, a mock-view of an OOH media content medium of the identified particular OOH media content mediums, wherein the mock-view includes the media content from the user; and
display, at the GUI of the platform, the mock-view.

15. A method for building an out of home (OOH) media content campaign comprising:
receiving, at a platform, a user input associated with the OOH media content campaign, wherein the platform is configured to identify a particular OOH media content medium of a plurality of OOH media content mediums that has a particular location and a particular medium type, wherein the platform identifies the particular OOH media content medium based on a selection of one or more parameters of a plurality of parameters associated with locations and medium types of the plurality of OOH media content mediums;
modifying via prompt engineering a predesigned prompt based on the user input and data of a datastore, wherein the data includes information associated with the locations and the medium types of the plurality of OOH media content mediums, and wherein the datastore is accessible by the platform;
transmitting the modified predesigned prompt to an artificial intelligence (AI), the AI is trained to identify the one or more parameters of a plurality of parameters associated with locations and medium types of the plurality of OOH media content mediums;
receiving, from the AI, a response to the modified predesigned prompt indicating the one or more parameters of the plurality of parameters associated with locations and medium types of the plurality of OOH media content mediums;
selecting, based on the response, the one or more parameters associated with locations and medium types of the plurality of OOH media content mediums; and
causing the platform to identify the particular OOH media content medium having the particular location and the particular medium type based on the selected one or more parameters.

16. The method for building the out of home (OOH) media content campaign of claim 15, wherein the plurality of parameters associated with locations and medium types of the plurality of OOH media content mediums are characteristics of the OOH media content campaign further comprising:
an OOH media content campaign target location;
an OOH media content campaign target audience;
an OOH media content campaign budget;
an OOH media content campaign ad play price;
an OOH media content campaign ad play frequency;
an OOH media content campaign duration; or
an OOH media content campaign medium type.

17. The method for building the out of home (OOH) media content campaign of claim 15, wherein the data of the datastore further comprises:
a medium type of the plurality of OOH media content mediums;
an availability of the plurality of OOH media content mediums;
a performance metric of the plurality of OOH media content mediums;
an audience of the plurality of OOH media content mediums;
a location of the plurality of OOH media content mediums;
a price of the plurality of OOH media content mediums; or
an owner of the plurality of OOH media content mediums.

18. The method for building the out of home (OOH) media content campaign of claim 15, wherein the medium type of the particular OOH media content medium comprises one of:
a digital billboard;
a mobile display;
a public electronic panel; or
a vehicle advertisement panel.

19. The method for building the out of home (OOH) media content campaign of claim 15, wherein the user input comprises:
a natural language text;
an attachment;
an image; or
a video.

20. The method for building the out of home (OOH) media content campaign of claim 15, further comprising:
in response to receiving the user input, generating a reply to the user input, the reply requesting a second user input;
receiving the second user input, the second user input based on the reply; and
modifying via prompt engineering the predesigned prompt based on the user input, the second user input, and the data of the datastore.
